(19) United States
(12) Patent Application Publication
(10) Pub. No.: US 2023/0408306 A1
(43) Pub. Date: Dec. 21, 2023

(54) SENSOR DEVICE, FAULT DIAGNOSIS SYSTEM, AND METHOD OF INSTALLING SENSOR DEVICE

(71) Applicant: Japan Aerospace Exploration Agency, Tokyo (JP)

(72) Inventors: Kohji TOMINAGA, Tokyo (JP); Go FUJII, Tokyo (JP); Taiichi NAGATA, Tokyo (JP); Daichi WADA, Tokyo (JP); Shinsaku HISADA, Tokyo (JP); Kaname KAWATSU, Tokyo (JP); Tokio KASAI, Tokyo (JP)

(21) Appl. No.: 18/333,970

(22) Filed: Jun. 13, 2023

(30) Foreign Application Priority Data
Jun. 17, 2022 (JP) 2022-098099

(51) Int. Cl. G01D 5/353; G01B 11/16

(52) U.S. Cl. CPC G01D 5/35367; G01B 11/165

(57) ABSTRACT

A sensor device that makes it possible to simultaneously measure a plurality of portions in a pipe while suppressing optical loss even when the diameter of the pipe is relatively small.

The sensor device includes an optical fiber in which a plurality of FBG sensors are formed and a detection unit that causes light to be incident on the optical fiber and detects reflected light from at least one of the plurality of FBG sensors. The portion of the optical fiber in which the plurality of FBG sensors are formed is wound around a pipe so as to form a winding angle which is a perpendicular or acute angle with an axis of the pipe in a side view of the pipe viewed from the portion of the optical fiber in which the FBG sensors are formed.

### BACKGROUND OF THE INVENTION

### Field of the Invention

The present invention relates to a sensor device, a fault diagnosis system, and a method of installing a sensor device.

### Description of Related Art

In the past, pressure fluctuations in pipes installed inside a reactor containment vessel have been monitored by a monitoring system (see, for example, Patent Document 1). The monitoring system is constituted by a strain measurement unit, an optical fiber, a converter, and a monitoring device.

The strain measurement unit is attached to the pipe in a circumferential direction. The optical fiber guides an optical signal measured by the strain measurement unit. The converter converts the optical signal into a voltage signal. The monitoring device observes an output signal from the converter.

On the other hand, a fault diagnosis system that diagnoses equipment faults in a spacecraft liquid propulsion system is known (see, for example, Patent Document 2). A propulsion control module in a spacecraft liquid propulsion system includes three thrusters, a fuel tank, an oxidizing agent tank, a first supply pipe (pipe), a second supply pipe, a pressure sensor, and a control unit.

The first supply pipe includes a main pipe and a first branch pipe that branches from the main pipe toward the three thrusters. The second supply pipe includes a main pipe and a second branch pipe that branches from the main pipe toward the three thrusters.

Each thruster is supplied with fuel from the fuel tank through the first supply pipe and supplied with an oxidizing agent from the oxidizing agent tank through the second supply pipe.

### PATENT DOCUMENT

[Patent Document 1] Japanese Unexamined Patent Application, First Publication No. 2008-256681
[Patent Document 2] Japanese Unexamined Patent Application, First Publication No. 2021-124045

### SUMMARY OF THE INVENTION

However, in the monitoring system of Patent Document 1 and the fault diagnosis system of Patent Document 2, an attempt to simultaneously measure a plurality of portions in the pipe leads to increases in the number of optical fibers, the number of pressure sensors, and the number of cables connected to the pressure sensors, resulting in an increase in the number of components of the device.

In addition, as in the monitoring system of Patent Document 1, the optical fiber that guides an optical signal may be used. In this case, when the optical fiber is wound around the pipe and the outside diameter of the pipe is relatively small, there may be concern of a decrease in the radius of curvature of the wound optical fiber and an increase in the optical loss of the optical signal.

The present invention was contrived in view of such problems, and an object thereof is to provide a sensor device that makes it possible to simultaneously measure a plurality of portions in a pipe while suppressing an increase in the number of components of the device and to make a measurement while suppressing optical loss even in a case where the outside diameter of the pipe is relatively small, a fault diagnosis system including this sensor device, and a method of installing this sensor device.

In order to solve the above problems, this invention proposes the following means.

(1) According to a first aspect of the present invention, there is provided a sensor device including: an optical fiber in which a plurality of FBG sensors are formed; and a detection unit that causes light to be incident on the optical fiber and detects reflected light which is the light reflected from at least one of the plurality of FBG sensors, wherein a portion of the optical fiber in which the plurality of FBG sensors are formed is wound around a pipe so as to form a winding angle which is a perpendicular or acute angle with an axis of the pipe in a side view of the pipe viewed from the portion of the optical fiber in which the FBG sensors are formed.

In this invention, the optical fiber in which a plurality of FBG sensors are formed is wound around the pipe. Therefore, for example, when the pipe is distorted in the circumferential direction due to fluid flowing through the pipe, a portion of the optical fiber in which the plurality of FBG sensors are formed is also distorted integrally with the pipe.

Some light incident on the optical fiber from the detection unit is reflected from the plurality of FBG sensors which are distorted in accordance with the flow of fluid, and becomes reflected light. The plurality of FBG sensors are distorted and the detection unit detects, for example, a change in intensity distribution with respect to the wavelength of the reflected light, so that portions of the pipe in which the plurality of FBG sensors are provided can be simultaneously measured with one optical fiber. Since only one optical fiber is used when the plurality of portions are measured, it is possible to suppress an increase in the number of components of the sensor device.

In addition, the portion of the optical fiber in which the plurality of FBG sensors are formed is wound around the pipe so as to form a winding angle which is a perpendicular or acute angle with the axis of the pipe in a side view of the pipe viewed from the portion of the optical fiber in which the FBG sensors are formed. Therefore, even in a case where the outside diameter of the pipe is relatively small, it is possible to suppress a decrease in radius of curvature of the optical fiber wound around the pipe. This makes it possible to make a measurement while suppressing the optical loss of the light sent through the optical fiber.

(2) A second aspect of the present invention may be the sensor device according to the above (1), wherein the winding angle is appropriately determined in accordance with a diameter of the pipe.

In this invention, it is possible to appropriately determine the winding angle in accordance with the diameter of the pipe.

(3) According to a third aspect of the present invention, there is provided a fault diagnosis system including: the sensor device according to the above (1) or (2); a calculation unit that calculates a plurality of acquired frequency response functions which are frequency response functions of the plurality of FBG sensors on the basis of detection results of the detection unit; a storage unit that stores a plurality of normal frequency response functions which are frequency response functions in a plurality of portions of the pipe in which the plurality of FBG sensors are disposed, obtained from analysis results obtained by simulating a state in which fluid flows normally through the pipe or experimental results in which the fluid flows normally through the pipe; and a determination unit that compares the plurality of acquired frequency response functions with the plurality of normal frequency response functions to determine whether there is an abnormality in a flow of the fluid in the pipe.

In this invention, the storage unit stores a plurality of normal frequency response functions in a plurality of portions of the pipe in which the plurality of FBG sensors are disposed, in advance, obtained from analysis results obtained by simulating a state in which fluid flows normally through the pipe or experimental results in which the fluid flows normally through the pipe.

In this state, the calculation unit calculates a plurality of acquired frequency response functions of the plurality of FBG sensors on the basis of the detection results of the detection unit. The determination unit compares the plurality of acquired frequency response functions with the plurality of normal frequency response functions to determine whether there is an abnormality in the flow of the fluid in the pipe, and thus it is possible to determine whether there is an abnormality in a plurality of portions of the pipe in which the plurality of FBG sensors are disposed on the basis of the frequency response functions.

(4) A fourth aspect of the present invention may be the fault diagnosis system according to the above (3), wherein the determination unit specifies a portion or range in which an abnormality has occurred in the pipe.

In this invention, it is possible to specify a predetermined portion or a predetermined range in which there is an abnormality in the pipe.

(5) A fifth aspect of the present invention may be the fault diagnosis system according to the above (4), wherein the determination unit determines that an abnormality has occurred in a predetermined portion of the pipe when a processing result focusing on a relationship between the acquired frequency response function and the normal frequency response function corresponding to the predetermined portion is equal to or greater than a threshold determined in advance.

In this invention, the determination unit can fairly and rapidly determine a predetermined portion in which an abnormality has occurred by comparing this threshold with the processing result on the basis of a numerical value determined in advance called a threshold.

(6) According to a sixth aspect of the present invention, there is provided a sensor device installation method of winding a sensor device around a pipe, the sensor device including an optical fiber in which a plurality of FBG sensors are formed and a detection unit that causes light to be incident on the optical fiber and detects reflected light which is the light reflected from at least one of the plurality of FBG sensors, wherein the method includes winding a portion of the optical fiber in which the plurality of FBG sensors are formed around the pipe so as to determine an appropriate winding angle in accordance with a pipe diameter and to form a winding angle which is a perpendicular or acute angle with an axis of the pipe in a side view of the pipe viewed from the portion of the optical fiber in which the FBG sensors are formed.

In this invention, the optical fiber in which a plurality of FBG sensors are formed is wound around the pipe. Therefore, for example, when the pipe is distorted in the circumferential direction due to fluid flowing through the pipe, a portion of the optical fiber in which the plurality of FBG sensors are formed is also distorted integrally with the pipe.

Some light incident on the optical fiber from the detection unit is reflected from the plurality of FBG sensors which are distorted in accordance with the flow of fluid, and becomes reflected light. The plurality of FBG sensors are distorted and the detection unit detects, for example, a change in intensity distribution with respect to the wavelength of the reflected light, so that portions of the pipe in which the plurality of FBG sensors are provided can be simultaneously measured with one optical fiber. Since only one optical fiber is used when the plurality of portions are measured, it is possible to suppress an increase in the number of components of the sensor device.

In addition, the portion of the optical fiber in which the plurality of FBG sensors are formed is wound around the pipe so as to form a winding angle which is a perpendicular or acute angle with the axis of the pipe in a side view of the pipe viewed from the portion of the optical fiber in which the FBG sensors are formed. Therefore, even in a case where the outside diameter of the pipe is relatively small, it is possible to suppress a decrease in radius of curvature of the optical fiber wound around the pipe. This makes it possible to make a measurement while suppressing the optical loss of the light sent through the optical fiber.

In the sensor device, the fault diagnosis system, and the method of installing a sensor device according to the present invention, it is possible to simultaneously measure a plurality of portions of the pipe while suppressing an increase in the number of components of a device and to make a measurement while suppressing optical loss even in a case where the outside diameter of the pipe is relatively small.

### BRIEF DESCRIPTION OF THE DRAWINGS

FIG. 1 is a diagram illustrating an outline of a piping system to be diagnosed by a fault diagnosis system according to an embodiment of the present invention.

FIG. 2 is a diagram illustrating a schematic configuration of the fault diagnosis system.

FIG. 3 is a side view illustrating a state in which an optical fiber of the fault diagnosis system is wound around a first pipe of the piping system.

FIG. 4 is a side view illustrating a state in which the optical fiber of the fault diagnosis system is wound around a second pipe of the piping system.

FIG. 5 is a diagram illustrating changes in pressure over time before correction based on acute angles is performed.

FIG. 6 is a diagram illustrating changes in pressure over time after correction based on acute angles is performed.

FIG. 7 is a diagram illustrating changes in gain of a frequency response function with respect to frequency.

### DETAILED DESCRIPTION OF THE INVENTION

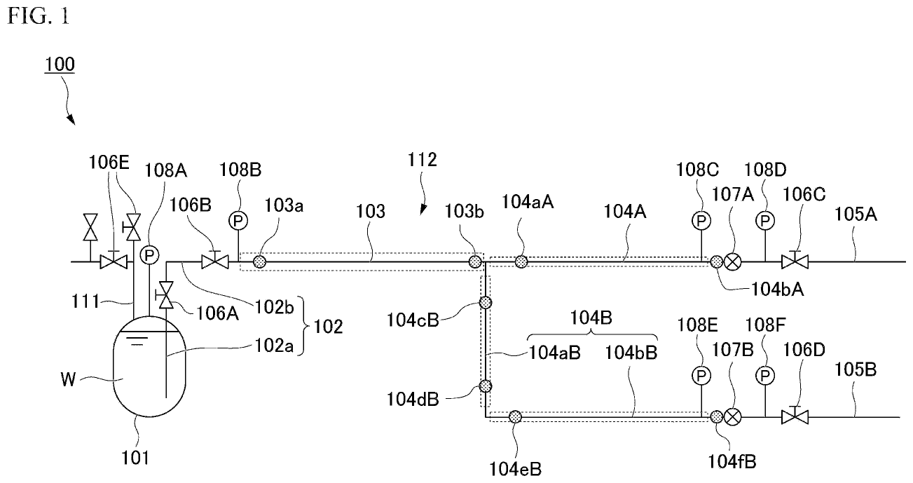

Hereinafter, an embodiment of a sensor device, a fault diagnosis system, and a method of installing a sensor device according to the present invention will be described with reference to FIGS. 1 to 7.

First, a piping system 100 to be diagnosed by a fault diagnosis system will be described with reference to FIG. 1.

The configuration of the piping system 100 is not limited insofar as the piping system includes pipes to be described later. For example, the piping system 100 includes a tank 101, a first connection pipe 102, a first pipe (pipe) 103, a plurality of second pipes (pipes) 104A and 104B, second connection pipes 105A and 105B, valves 106A to 106E, electromagnetic valves 107A and 107B, and pressure sensors 108A to 108F. Meanwhile, in FIG. 1, images having the outside diameters of the first pipe 103 and the second pipes 104A and 104B are shown by dotted lines. Hereinafter, the first pipe 103 and the second pipes 104A and 104B are collectively referred to as the pipe 112.

Meanwhile, there is no limitation on the positions of valves, electromagnetic valves, and pressure sensors to be disposed in the piping system 100, the numbers of these components, and the like.

For example, water (fluid) W is contained in the tank 101. The inside of the tank 101 is preferably pressurized by gas or the like. Meanwhile, the fluid contained in the tank 101 is not limited to the water W, and may be fuel, an oxidizing agent, or the like.

The first connection pipe 102 has a first piece 102a and a second piece 102b. The first piece 102a and the second piece 102b are each tubular. The first end of the first piece 102a is disposed near the bottom of the tank 101 in the tank 101. The first piece 102a extends in a vertical direction, and the second end of the first piece 102a located opposite to the first end protrudes further upward than the tank 101.

The second piece 102b extends along a horizontal plane from the upper end of the first piece 102a.

The first pipe 103 extends along the horizontal plane from the end of the second piece 102b of the first connection pipe 102 to which the first piece 102a is not connected.

The outside diameters of the second pipes 104A and 104B are smaller than the outside diameter of the first pipe 103. The second pipe 104A extends along the horizontal plane from the tip portion where the first pipe 103 extends.

The second pipe 104B has a first piece 104aB and a second piece 104bB. The first piece 104aB and the second piece 104bB are each tubular.

The first piece 104aB extends downward from the tip portion where the first pipe 103 extends. The second piece 104bB extends along the horizontal plane from the lower end of the first piece 104aB and opposite to the second pipe 104A in the vertical direction.

The second connection pipe 105A extends along horizontal plane from the tip portion where the second pipe 104A extends. The second connection pipe 105B extends along the horizontal plane from the tip portion where the second piece 104bB of the second pipe 104B extends.

Meanwhile, a discharge pipe 111 is connected to the tank 101.

The valves 106A to 106E can switch the pipe 112 and the like between an open state in which the water W flows and a closed state in which the water W does not flow. The valve 106A is provided on the first piece 102a of the first connection pipe 102. The valve 106B is provided on the second piece 102b of the first connection pipe 102.

The valve 106C is provided on the second connection pipe 105A. The valve 106D is provided on the second connection pipe 105B. The valves 106C and 106D can adjust the flow rate of the water W flowing through the second connection pipes 105A and 105B. The valve 106E is provided on the discharge pipe 111.

The electromagnetic valves 107A and 107B can switch the second connection pipes 105A and 105B between an open state in which the water W flows and a closed state in which the water W does not flow.

The electromagnetic valve 107A is provided on the end of the second connection pipe 105A which is connected to the second pipe 104A. The electromagnetic valve 107B is provided on the end of the second connection pipe 105B which is connected to the second pipe 104B.

The pressure sensor 108A measures the pressure inside the tank 101. The pressure sensor 108B measures the pressure inside the connecting portion between the second piece 102b of the first connection pipe 102 and the first pipe 103. The pressure sensor 108C measures the pressure inside the connecting portion between the second pipe 104A and the second connection pipe 105A. The pressure sensor 108D measures the pressure between the portions of the second connection pipe 105A which are provided with the valve 106C and the electromagnetic valve 107A.

The pressure sensor 108E measures the pressure inside the connecting portion between the second pipe 104B and the second connection pipe 105B. The pressure sensor 108F measures the pressure between the portions of the second connection pipe 105B which are provided with the valve 106D and the electromagnetic valve 107B.

In the piping system 100 configured as described above, an operator appropriately opens and closes the valves 106A, 106B, and 106E, appropriately adjusts the opening degrees of the valves 106C and 106D, and appropriately opens and closes the electromagnetic valves 107A and 107B. Thereby, it is possible to adjust the flow rate of the water W flowing out of the piping system 100 from the second connection pipes 105A and 105B.

At that time, the pressure of each portion in the piping system 100 can be measured by the pressure sensors 108A to 108F.

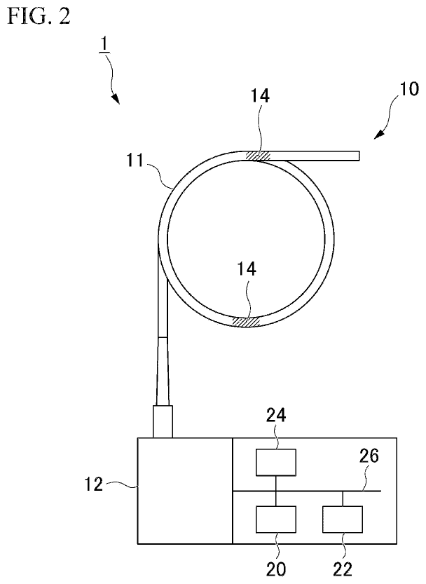

Next, a fault diagnosis system 1 will be described with reference to FIG. 2.

The fault diagnosis system 1 includes a sensor device 10 of the present embodiment, a calculation unit 20, a storage unit 22, and a determination unit 24.

The sensor device 10 has an optical fiber 11 and a detection unit 12.

For example, the optical fiber 11 has a core and a cladding that covers the outer circumferential surface of the core (not shown). A plurality of FBG (Fiber Bragg Grating) sensors 14 are formed in the core of the optical fiber 11. Meanwhile, in FIG. 2 and the subsequent drawings, the plurality of FBG sensors 14 are shown by hatching.

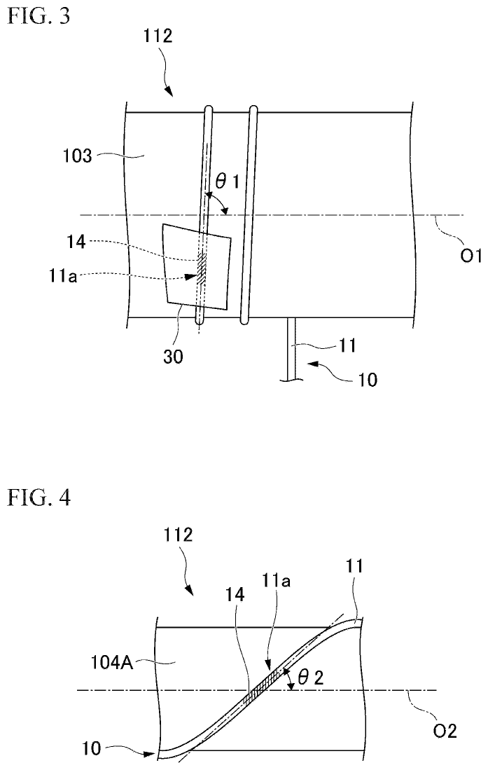

As shown in FIGS. 3 and 4, the portion of the optical fiber 11 where the plurality of FBG sensors 14 are formed (hereinafter referred to as a sensor forming portion 11a) is wound around the first pipe 103 and the second pipe 104A.

Here, as shown in FIG. 3, the axis (center axis) of the first pipe 103 is referred to as an axis O1. As shown in FIG. 4, the axis of the second pipe 104A is referred to as an axis O2.

More specifically, as shown in FIG. 3, the sensor forming portion 11a is wound around the first pipe 103 so as to form a winding angle θ1 which is an acute angle inclined with respect to the axis O1 in a side view of the first pipe 103 viewed from the sensor forming portion 11a side (when the first pipe 103 is viewed facing the sensor forming portion 11a). In other words, the sensor forming portion 11a is wound around the first pipe 103 so that the lead angle is the winding angle θ1.

Similarly, as shown in FIG. 4, the sensor forming portion 11a is wound around the second pipe 104A so as to form a winding angle θ2 which is an acute angle inclined with respect to the axis O1 in a side view of the second pipe 104A viewed from the sensor forming portion 11a side (when the second pipe 104A is viewed facing the sensor forming portion 11a). In other words, the sensor forming portion 11a is wound around the second pipe 104A so that the lead angle is the winding angle θ2.

Meanwhile, the winding angles θ1 and θ2 may be perpendicular (right-angled).

The winding angles θ1 and θ2 are appropriately determined in accordance with the diameters (outside diameters) of the pipes 103, 104A, and 104B. Specifically, the winding angle θ2 with respect to the second pipe 104A is preferably smaller than the winding angle θ1 with respect to the first pipe 103. The winding angles θ1 and θ2 are appropriately adjusted according to the outside diameter of the pipe 112, the material of the pipe 112, and the like.

The pipe 112 and the sensor forming portion 11a are fixed to each other by an adhesive, a tape 30 (see FIG. 3), or the like. When the pipe 112 is distorted in the circumferential direction, the sensor forming portion 11a is distorted integrally with the pipe 112.

The portions of the pipe 112 where the plurality of FBG sensors 14 are disposed are not particularly limited. As shown in FIG. 1, hereinafter, the plurality of portions of the first pipe 103 where the plurality of FBG sensors 14 are disposed are referred to as sensor installation portions 103a and 103b.

For example, the sensor installation portion 103a is the end of the first pipe 103 on the side connected to the first connection pipe 102. The sensor installation portion 103b is the end of the first pipe 103 on the side connected to the second pipe 104A.

Hereinafter, the plurality of portions of the second pipes 104A and 104B where the plurality of FBG sensors 14 are disposed are referred to as sensor installation portions 104aA, 104bA, and 104cB to 104fB.

The sensor installation portion 104aA is the end of the second pipe 104A on the side connected to the first pipe 103. The sensor installation portion 104bA is the end of the second connection pipe 105A on the side connected to the second pipe 104A.

The sensor installation portion 104cB is the end of the first piece 104aB of the second pipe 104B on the side connected to the first pipe 103. The sensor installation portion 104dB is the end of the first piece 104aB on the side connected to the second piece 104bB. The sensor installation portion 104eB is the end of the second piece 104bB on the side connected to the first piece 104aB. The sensor installation portion 104fB is the end of the second connection pipe 105B on the side connected to the second pipe 104B.

Hereinafter, the sensor installation portions 103a, 103b, 104aA, 104bA, and 104cB to 104fB are referred to as the sensor installation portion 103a or the like.

As shown in FIG. 2, the detection unit 12 causes light to be incident on the optical fiber 11 and detects reflected light which is the light reflected from at least one of the plurality of FBG sensors 14.

The calculation unit 20, the storage unit 22, and the determination unit 24 are connected to each other through a bus 26. The bus 26 is connected to the detection unit 12.

The calculation unit 20 detects, for example, a change in intensity distribution with respect to the wavelength of the reflected light on the basis of the detection results of the detection unit 12. The calculation unit 20 then detects the strain of a plurality of sensor forming portions 11a from this relationship. The calculation unit 20 calculates the pressure of the pipe 112 at the sensor installation portion 103a or the like from the strain of the plurality of sensor forming portions 11a.

The calculation unit 20 performs frequency analysis on the calculated pressure and calculates a plurality of acquired frequency response functions which are frequency response functions of the plurality of FBG sensors 14. For example, the acquired frequency response function is a frequency response function of the calculated pressure with respect to frequency. More specifically, the calculation unit 20 calculates an acquired frequency response function corresponding to the sensor installation portion 103a, an acquired frequency response function corresponding to the sensor installation portion 103b, ⋅ ⋅ ⋅ , and an acquired frequency response function corresponding to the sensor installation portion 104fB.

The storage unit 22 stores a plurality of normal frequency response functions, frequency response function thresholds (thresholds), and the like. The plurality of normal frequency response functions are frequency response functions in the sensor installation portion 103a and the like.

More specifically, the plurality of normal frequency response functions are normal frequency response function corresponding to the sensor installation portion 103a, a normal frequency response function corresponding to the sensor installation portion 103b, ⋅ ⋅ ⋅ , and a normal frequency response function corresponding to the sensor installation portion 104fB.

The threshold of a mean squared error is a value determined in advance in order to determine an abnormality and normality.

The plurality of normal frequency response functions are obtained from analysis results obtained by simulating a state in which the water W flows normally through the pipe 112. In addition, the plurality of normal frequency response functions are also obtained from experimental results in which the water W flows normally through the pipe 112.

The wording “the water W flows normally” referred to here means that the inside of the pipe 112 is filled with the water W, fluid other than the water W such as air does not enter the pipe 112, and there is no abnormal flow rate of the water W due to the defective opening degrees of the valves 106A to 106E and the electromagnetic valves 107A and 107B.

The plurality of normal frequency response functions are frequency response functions unique to the piping system 100. The plurality of normal frequency response functions are obtained by performing analysis or experiments on a predetermined piping system. For example, the normal frequency response function has a gain that varies with frequency.

Before the piping system 100 is diagnosed with the fault diagnosis system 1, a plurality of normal frequency response functions and the threshold of a mean squared error are preferably stored in advance in the storage unit 22.

The determination unit 24 compares the plurality of acquired frequency response functions with the plurality of normal frequency response functions to determine whether there is an abnormality in the flow of the water W within the pipe 112. For example, the determination unit 24 determines that an abnormality has occurred in the predetermined portion when the processing result (analysis result) focusing on the relationship between the acquired frequency response function and the normal frequency response function corresponding to the predetermined portion of the pipe 112 is equal to or greater than a threshold determined in advance. For example, the processing result focusing on the relationship between the acquired frequency response function and the normal frequency response function is a mean squared error between the acquired frequency response function and the normal frequency response function, and the threshold is a threshold of a mean squared error.

More specifically, the determination unit 24 compares the acquired frequency response function and the normal frequency response function corresponding to the sensor installation portion 103a to calculate a mean squared error corresponding to the sensor installation portion 103a from these frequency response functions. Similarly, the determination unit 24 calculates mean squared errors corresponding to the sensor installation portions 103b, 104aA, 104bA, and 104cB to 104fB.

For example, in a case where the mean squared error corresponding to the sensor installation portion 103a is equal to or greater than the threshold determined in advance (threshold of a mean squared error) and the mean squared errors corresponding to the sensor installation portions 103b, 104aA, 104bA, and 104cB to 104fB are less than the threshold determined in advance, the determination unit 24 determines that an abnormality has occurred in the sensor installation portion 103a, and determines that the sensor installation portions 103b, 104aA, 104bA, and 104cB to 104fB are normal.

For example, in a case where the mean squared error corresponding to the sensor installation portions 103a and 103b adjacent to each other along the pipe 112 is equal to or greater than the threshold determined in advance and the mean squared error corresponding to the sensor installation portions 104aA, 104bA, and 104cB to 104fB is less than the threshold determined in advance, the determination unit 24 determines that an abnormality has occurred in the range of the first pipe 103 corresponding to between the sensor installation portion 103a and the sensor installation portion 103b.

As described above, the determination unit 24 specifies the portion (sensor installation portion) or range where an abnormality has occurred in the pipe 112.

Here, a method by which the determination unit 24 obtains a mean squared error will be described.

A frequency response function H(f) is expressed by Equation (1) using the Fourier spectrum A(f) of an input signal a and the Fourier spectrum B(f) of an output signal b.

$$H ( f ) = \frac{B ( f )}{A ( f )} \qquad ( 1 )$$

By multiplying the numerator and denominator on the right-hand side of Equation (1) by the complex conjugate A*(f) of the Fourier spectrum A(f) of the input signal a, H(f) is expressed as in Equation (2) using power spectrum Gₐₐ(f) of the input signal a and the cross spectrum G_{ba}(f) of the input signal a and the output signal b.

$$H ( f ) = \frac{B ( f ) \times {A}^{*} ( f )}{A ( f ) \times {A}^{*} ( f )} = \frac{{G}_{ba} ( f )}{{G}_{aa} ( f )} \qquad ( 2 )$$

The frequency response function H(f) of Equation (2) is used in a case where there is much noise in the Fourier spectrum B(f) of the output signal b, and random errors are minimized by averaging.

A method of installing a sensor device of the present embodiment (hereinafter also simply referred to as an installation method) is a method of winding the sensor device 10 around the pipe 112.

The installation method involves winding the sensor forming portion 11a around the pipe 112 so as to form the winding angles θ1 and θ2 which are acute angles inclined with respect to the axes O1 and O2 of the pipe 112 in a side view of the pipe 112 viewed from the sensor forming portion 11a side.

(Measurement Results of Pressure of Pipe Using Sensor Device)

Here, the results of measuring the pressure (strain) of the pipe 112 in the piping system 100 using the sensor device 10 will be described.

Meanwhile, pressure is measured by a pressure sensor (not shown) at the sensor installation portion 103a or the like in the pipe 112. The pressure measured by the pressure sensor and the pressure measured by the FBG sensor 14 of the sensor device 10 were compared with each other. The sensor forming portion 11a of the sensor device 10 is wound around the pipe 112 so as to form an acute angle θ inclined with respect to the axis.

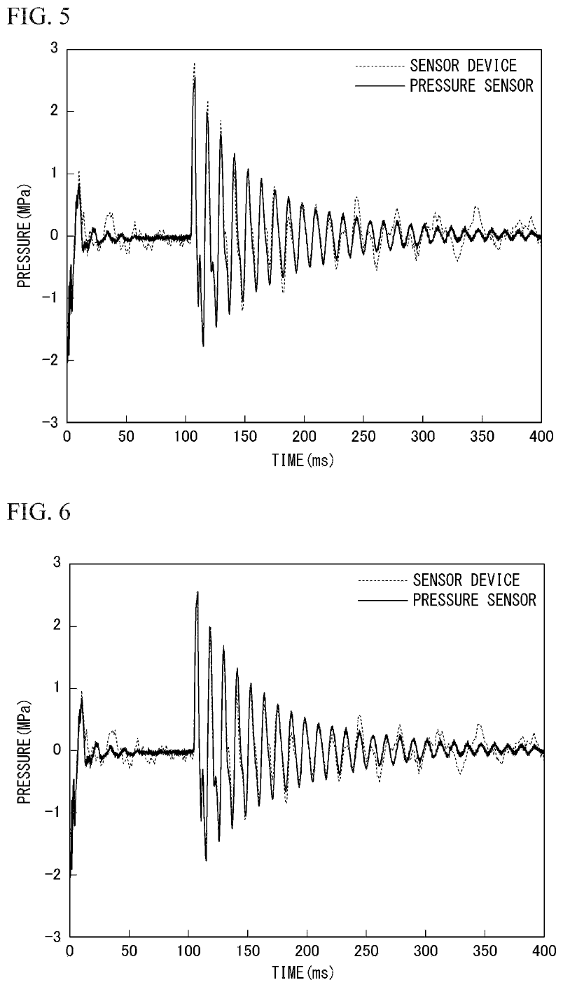

The results of the comparison are shown in FIG. 5. In FIG. 5, the horizontal axis represents time (ms (milliseconds)), and the vertical axis represents pressure (MPa (megapascal)).

In this case, the error of the maximum peak pressure measured by the sensor device 10 with respect to the pressure measured by the pressure sensor was 12%.

On the other hand, correction based on the acute angle θ was performed on the strain ε measured by the sensor device 10 to calculate the pressure. The correction based on the acute angle θ is performed using Equation (3). Equation (3) converts the strain ε into the pressure P using the inside diameter Rᵢ, outside diameter Rₒ, Young's modulus E, Poisson's ratio ν, and acute angle θ of the pipe.

$$P = - \frac{E}{2 ( 1 - v ) cos θ} \frac{{R}_{i}^{2} - {R}_{o}^{2}}{{R}_{i}^{2}} ε \qquad ( 3 )$$

The results of the comparison are shown in FIG. 6. In this case, the error of the maximum peak pressure measured by the sensor device 10 with respect to the pressure measured by the pressure sensor was 3.4%. It has been found that the accuracy of pressure (strain) measured by the sensor device 10 is improved by performing the correction based on the acute angle θ.

(Example of Frequency Response Function)

Next, an example of the normal frequency response function and the acquired frequency response function will be described.

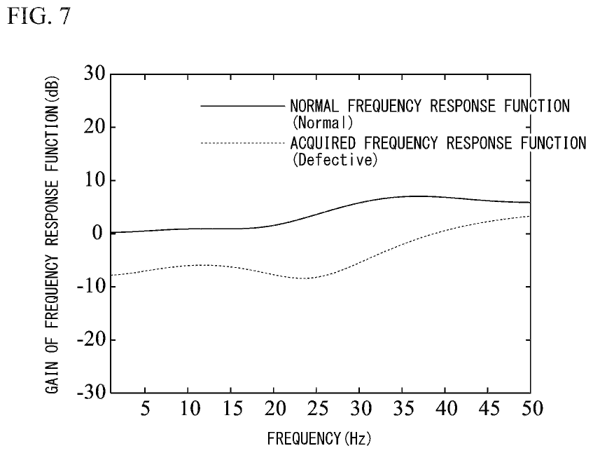

FIG. 7 shows changes in gain of a normal frequency response function and an acquired frequency response function with respect to frequency. In FIG. 7, the horizontal axis represents frequency (Hz (Hertz)), and the vertical axis represents the gain (dB (decibel)) of the frequency response function. The gain of the normal frequency response function is given by Equation (4). On the other hand, the gain of the acquired frequency response function is given by Equation (5).

20 log|H(f)∥_{Normal} (4)

20 log|H(f)∥_{Defective} (5)

The determination unit 24 determines that an abnormality has occurred when the mean squared error between the acquired frequency response function and the normal frequency response function is equal to or greater than the frequency response function threshold.

As described above, in the sensor device 10 of the present embodiment, the optical fiber 11 where the plurality of FBG sensors 14 are formed is wound around the pipe 112. Therefore, for example, when the pipe 112 is distorted in the circumferential direction due to the water W flowing through the pipe 112, a portion of the optical fiber 11 where the plurality of FBG sensors 14 are formed is also distorted integrally with the pipe 112.

Some light incident on the optical fiber 11 from the detection unit 12 is reflected from the plurality of FBG sensors 14 which are distorted in accordance with the flow of the water W, and becomes reflected light. The plurality of FBG sensors 14 are distorted and the detection unit 12 detects, for example, a change in intensity distribution with respect to the wavelength of the reflected light, so that the sensor installation portion 103a and the like can be simultaneously measured with one the optical fiber 11. Since only one optical fiber 11 is used when a plurality of portions are measured, it is possible to suppress an increase in the number of components of the sensor device 10.

In addition, the sensor forming portion 11a is wound around the pipe 112 so as to form the winding angles θ1 and θ2 which are acute angles inclined with respect to the axes O1 and O2 of the pipe 112 in a side view of the pipe 112 viewed from the sensor forming portion 11a side. Therefore, even in a case where the outside diameter of the pipe 112 is relatively small, it is possible to suppress a decrease in the radius of curvature of the optical fiber 11 wound around the pipe 112. This makes it possible to make a measurement while suppressing the optical loss of the light sent through the optical fiber 11.

The winding angles θ1 and θ2 are appropriately determined in accordance with the diameters of the pipes 103 and 104A. This makes is possible to appropriately determine the winding angles θ1 and θ2 in accordance with the diameters of the pipes 103 and 104A.

The winding angle θ2 with respect to the second pipe 104A may be smaller than the winding angle θ1 with respect to the first pipe 103. In this case, when the strain of the second pipe 104A of which the outside diameter is smaller than that of the first pipe 103 is measured, it is possible to more reliably suppress a decrease in the radius of curvature of the optical fiber 11 wound around the second pipe 104A.

In addition, in the fault diagnosis system 1 of the present embodiment, the storage unit 22 stores a plurality of normal frequency response functions in the sensor installation portion 103a and the like in advance obtained from analysis results obtained by simulating a state in which the water W flows normally through the pipe 112 or experimental results in which the water W flows normally through the pipe 112.

In this state, the calculation unit 20 calculates a plurality of acquired frequency response functions of the plurality of FBG sensors 14 on the basis of the detection results of the detection unit 12. The determination unit 24 compares the plurality of acquired frequency response functions with the plurality of normal frequency response functions to determine whether there is an abnormality in the flow of the water W in the pipe 112, and thus it is possible to determine whether there is an abnormality in the sensor installation portion 103a and the like on the basis of the frequency response functions.

The determination unit 24 specifies a portion or range where an abnormality has occurred in the pipe 112. Therefore, it is possible to specify a predetermined portion or a predetermined range in which there is an abnormality in the pipe 112. The determination unit 24 determines that an abnormality has occurred in the predetermined portion when the processing result focusing on the relationship between the acquired frequency response function and the normal frequency response function corresponding to the predetermined portion of the pipe 112 is equal to or greater than the threshold determined in advance. Therefore, the determination unit 24 can fairly and rapidly determine a predetermined portion in which an abnormality has occurred by comparing this threshold with the processing result on the basis of a numerical value determined in advance called a threshold.

In a case where the processing result focusing on the relationship between the acquired frequency response function and the normal frequency response function is a mean squared error between the acquired frequency response function and the normal frequency response function, the determination unit 24 can fairly and more rapidly determine a predetermined portion in which an abnormality has occurred by comparing this threshold with the mean squared error on the basis of a numerical value determined in advance called a threshold.

In addition, in the installing method of the present embodiment, the optical fiber 11 where the plurality of FBG sensors 14 are formed is wound around the pipe 112. Therefore, for example, when the pipe 112 is distorted in the circumferential direction due to the water W flowing through the pipe 112, a portion of the optical fiber 11 where the plurality of FBG sensors 14 are formed is also distorted integrally with the pipe 112.

Some light incident on the optical fiber 11 from the detection unit 12 is reflected from the plurality of FBG sensors 14 which are distorted in accordance with the flow of the water W, and becomes reflected light. The plurality of FBG sensors 14 are distorted and the detection unit 12 detects, for example, a change in intensity distribution with respect to the wavelength of the reflected light, so that the sensor installation portion 103a and the like can be simultaneously measured with one the optical fiber 11. Since only one optical fiber 11 is used when a plurality of portions are measured, it is possible to suppress an increase in the number of components of the sensor device 10.

In addition, the sensor forming portion 11a is wound around the pipe 112 so as to form the winding angles θ1 and θ2 which are acute angles inclined with respect to the axes O1 and O2 of the pipe 112 in a side view of the pipe 112 viewed from the sensor forming portion 11a side. Therefore, even in a case where the outside diameter of the pipe 112 is relatively small, it is possible to suppress a decrease in the radius of curvature of the optical fiber 11 wound around the pipe 112. This makes it possible to make a measurement while suppressing the loss of the light sent through the optical fiber 11.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, in the embodiment, a value different from the mean squared error may be used when the determination unit 24 determines an abnormality in the pipe 112.

In the fault diagnosis system, frequency spectrum data may be used instead of the frequency response function.

### EXPLANATION OF REFERENCES

1 Fault diagnosis system
10 Sensor device
11 Optical fiber
12 Detection unit
14 FBG sensor
20 Calculation unit
22 Storage unit
24 Determination unit
103 First pipe (pipe)
104A, 104B Second pipe (pipe)
112 Pipe
O1, O2 Axis
W Water (fluid)
θ1, θ2 Winding angle

1. A sensor device comprising:
an optical fiber in which a plurality of FBG sensors are formed; and
a detection unit that causes light to be incident on the optical fiber and detects reflected light which is the light reflected from at least one of the plurality of FBG sensors,
wherein a portion of the optical fiber in which the plurality of FBG sensors are formed is wound around a pipe so as to form a winding angle which is a perpendicular or acute angle with an axis of the pipe in a side view of the pipe viewed from the portion of the optical fiber in which the FBG sensors are formed.

2. The sensor device according to claim 1, wherein the winding angle is appropriately determined in accordance with a diameter of the pipe.

3. A fault diagnosis system comprising:
the sensor device according to claim 1;
a calculation unit that calculates a plurality of acquired frequency response functions which are frequency response functions of the plurality of FBG sensors on the basis of detection results of the detection unit;
a storage unit that stores a plurality of normal frequency response functions which are frequency response functions in a plurality of portions of the pipe in which the plurality of FBG sensors are disposed, obtained from analysis results obtained by simulating a state in which fluid flows normally through the pipe or experimental results in which the fluid flows normally through the pipe; and
a determination unit that compares the plurality of acquired frequency response functions with the plurality of normal frequency response functions to determine whether there is an abnormality in a flow of the fluid in the pipe.

4. The fault diagnosis system according to claim 3, wherein the determination unit specifies a portion or range in which an abnormality has occurred in the pipe.

5. The fault diagnosis system according to claim 4, wherein the determination unit determines that an abnormality has occurred in a predetermined portion of the pipe when a processing result focusing on a relationship between the acquired frequency response function and the normal frequency response function corresponding to the predetermined portion is equal to or greater than a threshold determined in advance.

6. A sensor device installation method of winding a sensor device around a pipe, the sensor device including an optical fiber in which a plurality of FBG sensors are formed and a detection unit that causes light to be incident on the optical fiber and detects reflected light which is the light reflected from at least one of the plurality of FBG sensors,
wherein the method comprises winding a portion of the optical fiber in which the plurality of FBG sensors are formed around the pipe so as to form a winding angle which is a perpendicular or acute angle with an axis of the pipe in a side view of the pipe viewed from the portion of the optical fiber in which the FBG sensors are formed.
